(19) United States
(12) Patent Application Publication
(10) Pub. No.: US 2002/0095803 A1
(43) Pub. Date: Jul. 25, 2002

(54) Compass ruler measurement device

(76) Inventor: Mark Meek, Niagara Falls, NY (US)

Correspondence Address: Mark Meek, 771 60th Street, Niagara Falls, NY, 14304, US

(21) Appl. No.: 09/765,164

(22) Filed: Jan. 19, 2001

(51) Int. Cl. G01C 17/02; G01B 3/12

(52) U.S. Cl. 33/342; 33/343; 33/354; 33/775

(57) ABSTRACT

A magnetic compass modified for use in linear, angular and, geometric as well as, or instead of, directional measure. Body (30), (35) manufactured to a predetermined circumference and made of a break-resistant material. Mounted on the base (33a) or, suspended from the top section (33b), is a freely pivoting or movable magnetic pointer (32) and a transparent, or partially transparent, upper section (35) so that the position of the pointer may be observed. Outer edge (31) made of slip-resistant material for contact and rotation on surface of structure being measured. Outer edge of base is calibrated with appropriate units positioned for use with pointer. Calibration (FIGS. 4a-c) could also possibly be inscribed on upper section of body instead of on the base. Most operations center around the locations of two variable points on the Compass Ruler, the contact point (37) and the zero point (36).

### BACKGROUND

1. Field of Invention

This invention relates to the adaptation of a magnetic compass as a measurement device for use in planar (linear and circular) and angular measurement rather than or in addition to its traditional use for directional measurement.

2. Description of Prior Art

The magnetic compass has been in use for centuries as a directional measurement device by taking advantage of the relative proximity of the earth's geographical and magnetic poles. It would seem logical that the compass could be made more accurate by making it larger in size, thereby increasing the possible accuracy in directional measurement, since any angular measurement can be made with increased accuracy with an increase of size, and therefore scale.

Yet magnetic compasses, or at least the functional part thereof, rarely were made larger than handheld size. The obvious reason for this is that the standard magnetic compass, consisting of a mounted or supported magnetic arm able to pivot over a calibrated dial in response to the earth's magnetic field thereby indicating compass direction, can only be considered as a general indicator of direction. This is because the earth's magnetic north does not correspond exactly with it's geographic north, making any increased accuracy in the compass gained by increased size effectively redundant.

Another reason against the traditional magnetic compass being made larger for more accuracy is the fact that steel ships, electric wires and, nearby iron ore affect the accuracy of the compass. Most importantly, telling direction using the stars gives considerably greater accuracy than doing so by magnetic compass. Finally, gyrocompasses, radio beacons and, satellite position finders have been developed in recent decades that render the old magnetic compass obsolete for use in determining direction for any kind of large scale transportation.

There was a circular device in the 1600's to determine the circumference of a large round structure by ratio, called the circumferentor, but it did not make use of the magnetic compass. The use of the circumferentor does not include planar measurements.

### OBJECTS AND ADVANTAGES

My claim is that a very important use of the magnetic compass has been ignored until now. The magnetic compass has always been considered as a directional rather than a planar or angular measurement tool. It was not worth it to try to make a magnetic compass larger to improve its directional accuracy, down to each of the 360 degrees for example, because of the device's inherent limitations as discussed above.

However, by combining a compass with a ruler (the Compass Ruler), accuracy in angular measure can be increased by scale and an entirely new dimension in measurement possibility and ease is thereby opened for common construction and household building projects.

Great accuracy can be gained by increased scale not in directional measurement with a magnetic compass but in angular difference measurement using magnetic north (or south) as an effectively infinite in distance stationary reference point. If a building project is in progress in one geographical location then the difference between magnetic and geographical north or south is effectively irrelevant. The principle is similar to a plumb using earth's gravity as a reference point and has very useful applications in common building and construction projects.

There are many common household and construction measurement tasks which are tedious and time-consuming and require two or more persons that the Compass Ruler will make quick and easy and able to be accomplished by only one person. Furthermore, the Compass Ruler will be able to perform some tasks with a reasonable degree of accuracy that are normally done by an expensive surveying team. This invention thereby solves a long-existing but as of yet unsolved need using a new principle of operation of the traditional magnetic compass.

The possibilities opened by adapting the magnetic compass for everyday planar and angular measurement applications are almost unlimited. The traditional magnetic compass has not been used in this capacity, at least not modified for use as a common household tool. It's use in this capacity offers so many advantages that if it were in fact obvious, it surely would have been implemented on a large scale by now.

The incredible fact that the vast planar measurement potential of the traditional magnetic compass has been ignored until now can only be explained by realizing how deeply we have been conditioned since childhood to consider this device as a tool for directional measurement alone. Builders and navigators have traditionally been separate cliques with very different tools and terminology and with little apparent reason to be interested in each other's tools.

Accordingly, aside from the objects and advantages of the Compass Ruler described in my above patent, several objects and advantages of the present invention are:

a) to provide an all-in-one measurement tool that is easy to use for common applications.

b) to make possible or at least less cumbersome, measurement tasks which are usually done with other common measurement tools such as tape measure, builder's square and mason's string.

c) to reduce the proportion of measurement tasks in which it is necessary to call in and pay professional surveyors.

d) to provide an educational tool for mathematics and physics.

e) to make possible more angles (other than right angles) and curves in household building projects.

More objects and advantages will certainly become apparent when the Compass Ruler comes into widespread use.

### DRAWING FIGURES

FIGS. 1a-d show four views of the Compass Ruler.

FIG. 1a shows the bottom view.

FIG. 1b shows the top view.

FIG. 1c shows the side view.

FIG. 1d shows the perspective view.

FIG. 2 shows the traditional magnetic compass.

FIG. 3 shows the exploded view of the Compass Ruler.

FIGS. 4a-c shows possible calibrations of the Compass Ruler.

FIG. 4a shows calibration in feet and inches.

FIG. 4b shows calibration in angular degrees.

FIG. 4c shows calibration in metric.

FIG. 5 shows the zero point 36 and the contact point 37 of the Compass Ruler.

FIGS. 6a-b show the Compass Ruler positioned for measurement of circumference of a large circular structure.

FIG. 6a shows the large-scale view.

FIG. 6b shows the close-up view.

FIGS. 7a-b shows the start and finish points of measurment of the circumference of a large circular structure with the Compass ruler.

FIGS. 8a-b shows the two measurements taken with the Compass Ruler to verify or measure an angle between two walls comprising a corner.

FIG. 9 shows a builder's square.

FIG. 10 shows the use of the Pythagorean theorem to measure or verify a right angle.

FIGS. 11a-b shows the two measurements taken with the Compass Ruler to measure or verify the angle between two walls.

FIGS. 12a-b shows the two measurements taken with the Compass Ruler to measure or verify the angle between two walls which do not intersect and may have bushes or another visual obstruction between them.

FIGS. 13a-c shows the measurements taken with the Compass Ruler to verify or measure the straightness or curvature of a wall or fence.

FIGS. 14a-b shows the measurements taken with the Compass Ruler to measure or verify parallality of two walls.

FIGS. 15a-b shows the measurements taken to verify or measure the angles of two billboards along aroad.

FIGS. 16a-b shows measuring a distance by parallax using the Compass Ruler.

FIG. 16a shows measurement of the distance between a local point and a distant visible point.

FIG. 16b shows the locating of a plotted distant point using the Compass Ruler.

FIG. 18 shows the Compass Ruler positioned with a straightedge for measurement of distant points as in FIG. 16a-b.

FIG. 19 shows use of multiple distant points for mapping.

FIG. 20 shows creation of a multiple baseline for measurement of a distant point.

FIG. 21 shows measurements taken with the Compass Ruler in mapping of a path or stream.

FIG. 22 shows a ruler 39a and a cotangent table 39b inscribed on the Compass Ruler.

FIG. 23 shows use of the Compass Ruler for linear measurement with a “leash” 40.

FIG. 24 shows a plumb that could be combined with the Compass Ruler.

FIG. 25 shows a possible adaptation of the Compass Ruler for measuring the sway in the wind of a billboard.

FIG. 26 shows the possible combination of the Compass Ruler with a straightedge tipped with a laser pointer 41 for use in distance measurement as in FIGS. 16.

FIG. 27 shows the possible adaptation of the Compass Ruler for repetitive measure or verification of a particular angle, a right angle in this case.

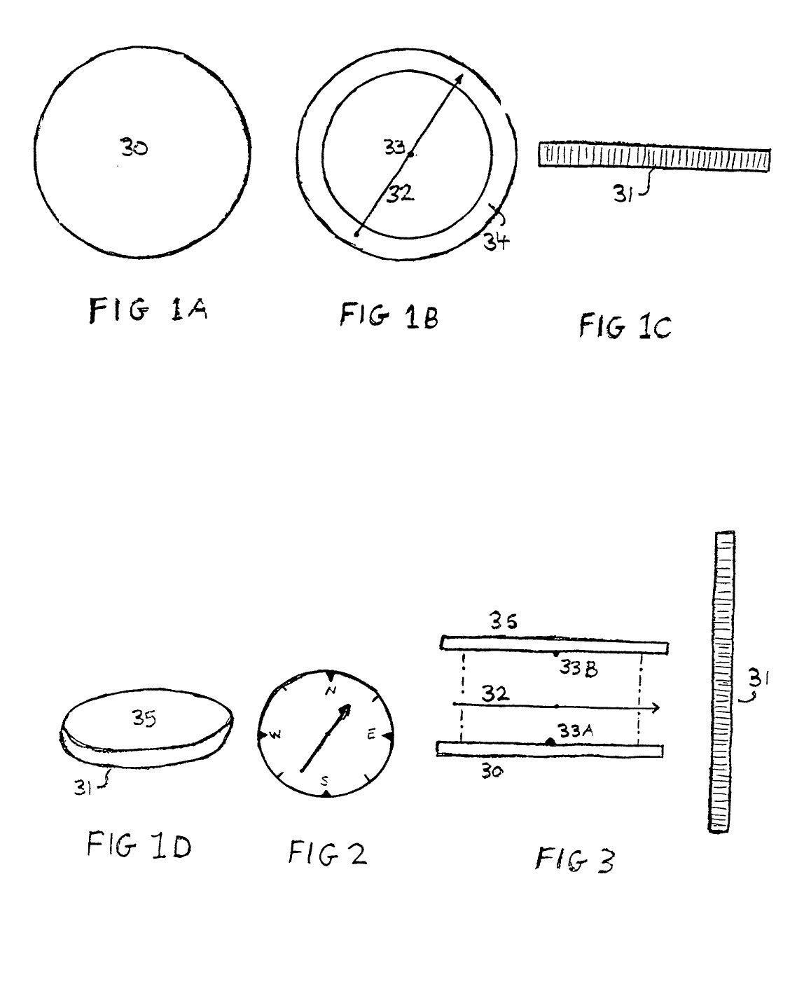

### REFERENCE NUMERALS IN DRAWINGS

30 base

31 side

32 pointer

33a mounting

33b suspension

34 calibration area

35 top

36 zero point

37 contact point

38 accompanying straightedge

39a inscribed ruler

39b inscribed cotangent table

41 laser pointer

### SUMMARY

In accordance with the present invention a magnetic compass modified for use in linear, angular and, geometric measurement as well as, or in addition to, it's traditional use in directional measurement.

### DESCRIPTION

The basic Compass Ruler is to consist of a similar setup to the traditional magnetic compass FIG. 2. The primary difference is in size and calibration and, possibly shape. The Compass Ruler may be larger than the traditional compass for increased angular measurement accuracy, since directional accuracy is not its primary purpose. It will be made to any convenient, but carefully measured, size. It's circumference most likely will be, but will not be limited to, a commonly used whole unit such as a meter or a yard.

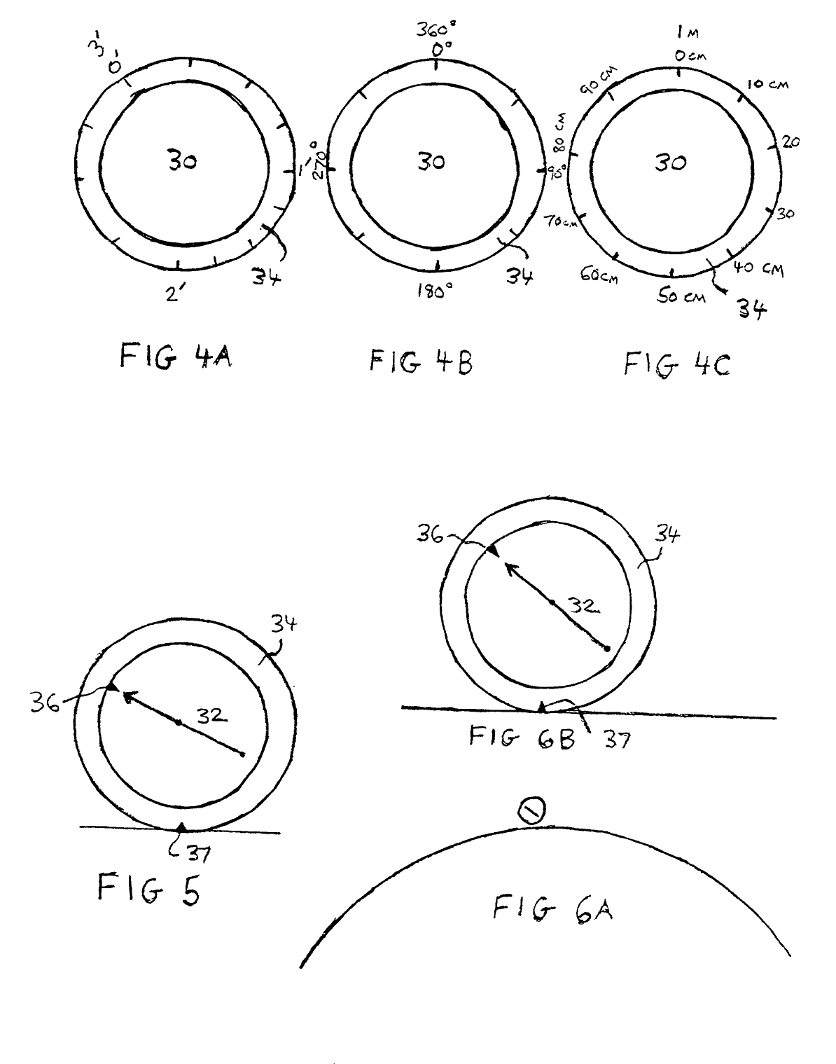

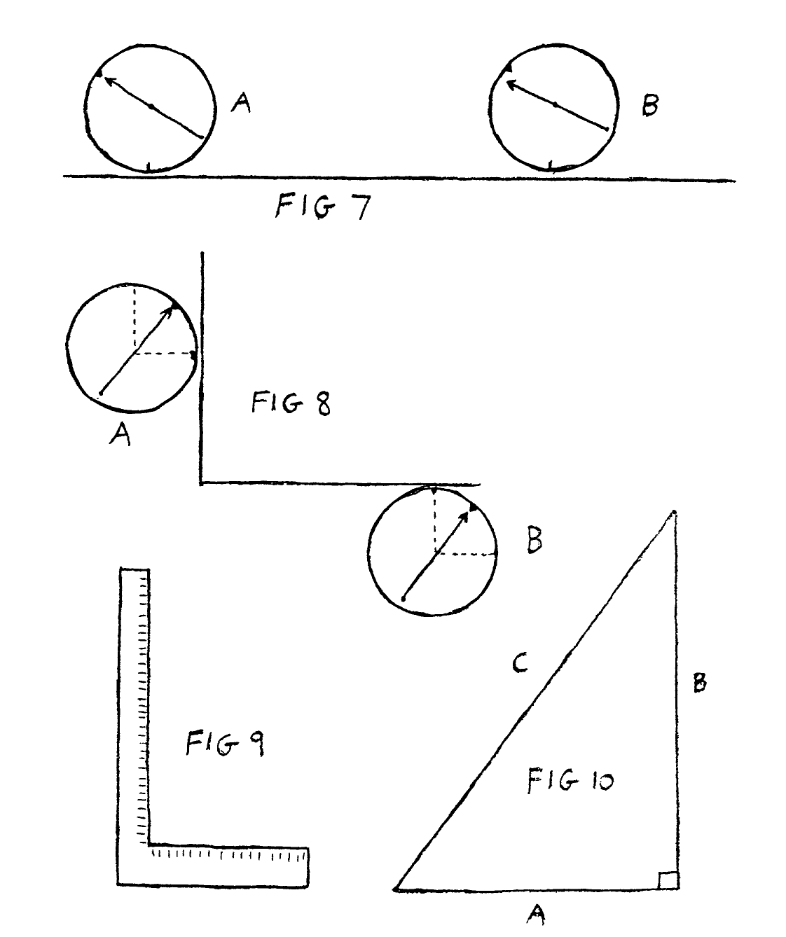

The Compass Ruler should have a calibrated edge for measuring 34. There are a number of possibilities for this. Most probably it will have an angular scale inscribed, probably in degrees but possibly also in units like radians or grads FIG. 4b. The cardinal compass directions can be included for directional measurement. A circular adaptation of a linear measure such as a yardstick FIG. 4a or meterstick FIG. 4c can be inscribed, depending on the Compass Ruler's circumference. A simple scale such as, but not limited to, 0-100 can also be inscribed to measure percentage of a circle (redundant if a meterstick is inscribed).

As in the traditional compass, it will have a magnetic and freely pivotal mounted or suspended pointer 32 to respond to earth's magnetic field. The edge of the Compass ruler will be calibrated as a traditional compass is FIG. 4a-c, but not necessarily or only in the points of the directional compass. The body of the Compass Ruler 30, 35 will probably be made of, but not limited to, a convenient and lightweight but break-resistant material such as plastic or aluminum. The outer edge of the Compass Ruler will be made of a surface likely to produce minimal slippage 31 and can be notched for more accurate measurement such as a polygon of 360 sides for measuring exact angles in degrees, instead of a smooth circular circumference.

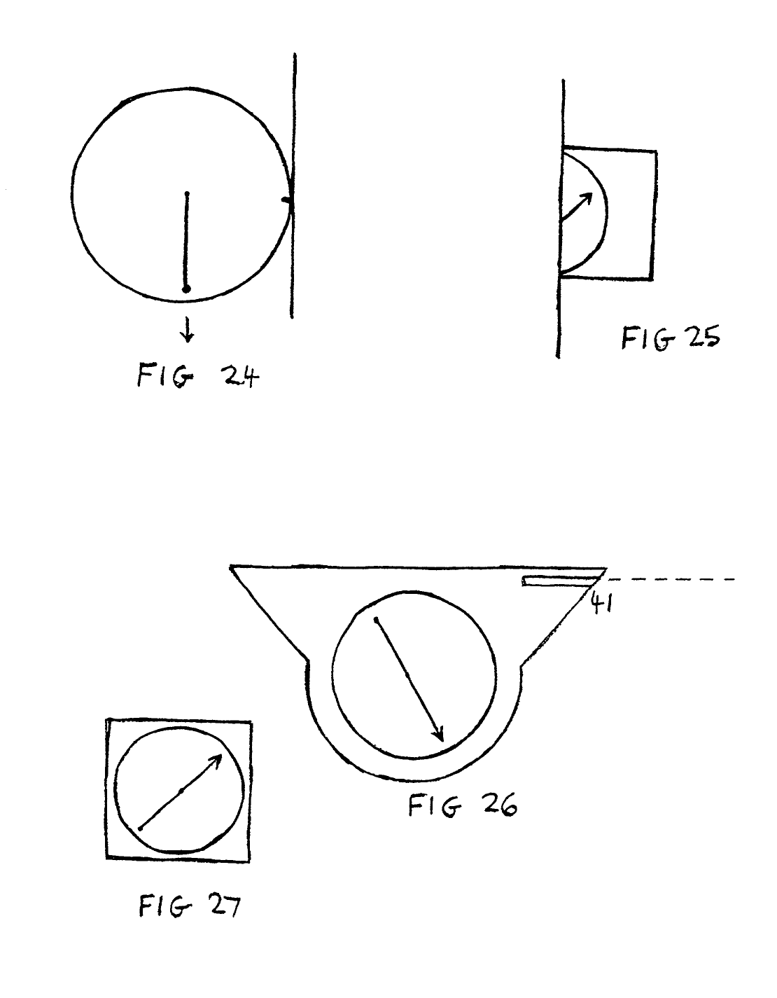

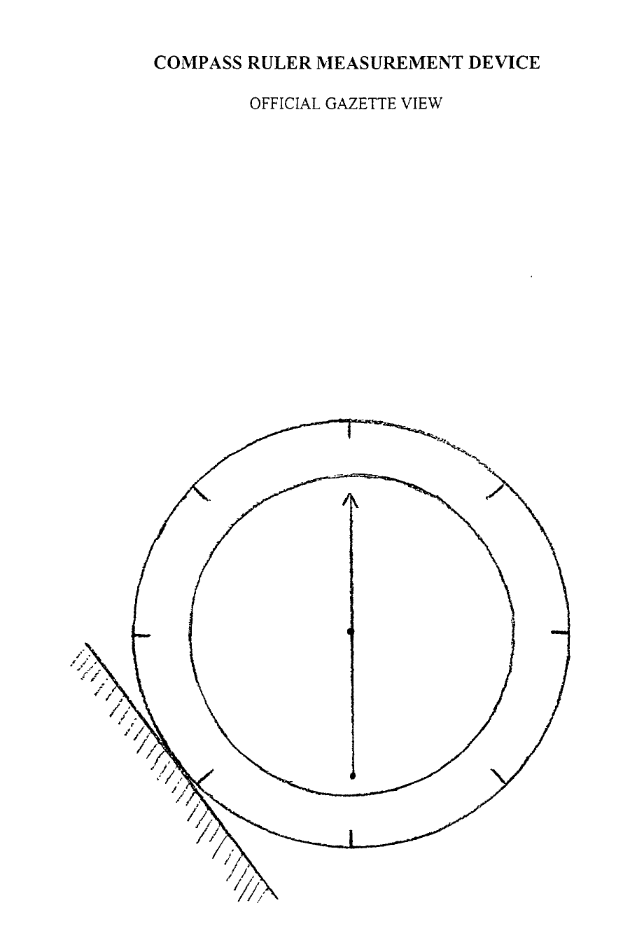

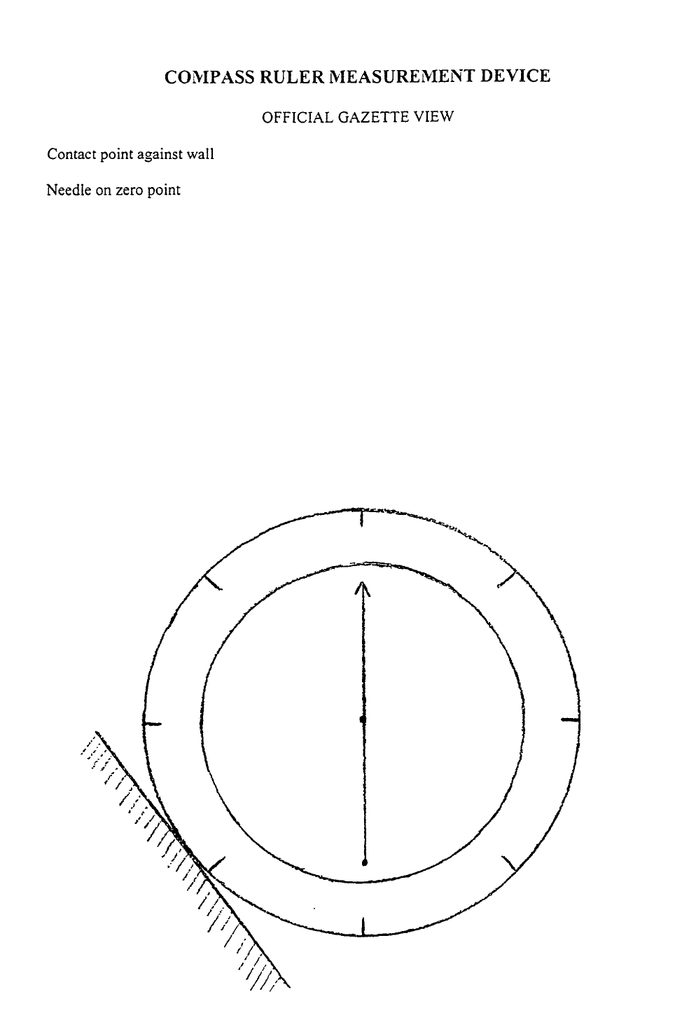

The Compass Ruler may be combined with other devices such as a plumb FIG. 24 or a straight-edge FIG. 26. it may come with additions such as a “leash” 40 to assist in it's use for linear measurement FIG. 23. To make it a more complete measurement device, it may have inscribed on it such additions as a standard ruler or a table of cotangents FIG. 22.

The Compass Ruler is especially amenable to an electronic or otherwise automated version. It could be set to a mode in which it would automatically calculate and display the angular difference of two measurements taken on two walls to determine if the walls are in fact parallel or at right angles. Another mode may automatically give the cotangent of the angular difference between the two lines used in distance measurement or multiply that cotangent by the length of the baseline to display the distance between the measurement points. An automated Compass Ruler could quickly display the circumference of any large round object by calculating, with a built-in calculator, how far the Compass Ruler had turned along the side of the object compared to the proportion of a complete circle that the movement of the Compass Ruler had taken.

### OPERATIONS

The operation of the Compass Ruler is simple and revolves around two points, the zero point 36 and the contact point 37 FIG. 5. The zero point is wherever the pointer is pointing to at any given time. Zeroing the pointer refers to rotating the Compass Ruler so that the needle points to the assigned zero point on the Compass Ruler. The zero point on the Compass Ruler should be assigned to the begin/end point of whatever scale is inscribed as the Compass Ruler's calibration. If the Compass Ruler was calibrated in degrees, the zero point would most logically be assigned to the 0, 360 degree point on the calibration of the Compass Ruler. The contact point is the point on the edge of the Compass Ruler that is in contact with the surface of whatever is being measured, such as a wall 37 in FIG. 6b. Both the zero point and contact point are variable and it is the relationship between the two points that will be used in the vast majority of the measurements done with the Compass Ruler.

The possible applications of the compass ruler in common building tasks is almost unlimited. Lets consider a few building applications of the Compass ruler. Try to imagine accomplishing these tasks with a builder's square, tape measure, mason's string or, any other common measurement tool. This is only a few of the possible uses of the Compass Ruler. When it comes into widespread use, it is certain that many more applications will be found by users.

A) Measuring the Circumference of a Large Round or Semicircular Structure.

An oil-storage tank would be an ideal example. The Compass Ruler is of a convenient circumference such as, but not limited to, one yard or one meter. All that is necessary to accomplish this task is to zero the Compass Ruler against the side of the structure FIG. 6a, noting the numbered point on the Compass Ruler's edge which is against the side of the structure 37 when the Compass Ruler is zeroed FIG. 6b 36,. Then rotate the Compass Ruler one full turn until the starting point is once again against the side of the structure FIG. 7a-b, ensuring that slippage does not occur.

The Compass Ruler will have rotated 360 degrees but since the structure is round, the needle on the Compass Ruler will not be pointing to exactly the same point as at the beginning of the measurement. The difference will easily enable us to determine the circumference of the structure. Suppose we started with the needle of the Compass Ruler on zero and the needle was on 4 degrees when the rotation of the Compass Ruler against the side of the structure was complete. If we had a Compass Ruler with a circumference of one meter, that would mean that the circumference of the structure was (360/4)×1 meter. In other words, 90 meters circumference. If the structure is quite large, two or more rotations of the Compass Ruler could be performed for increased accuracy meaning that the 360 degree circle divided by the angular difference indicated by the magnetic needle after the rotations would be multiplied by two (or more) meters (or other unit) instead of one meter. Once the circumference of the object is obtained, the diameter can easily be found by dividing by pi (3.1416).

The accuracy of the Compass Ruler in performing this task should be at least equal to that of a tape measure. Measurement accuracy involved in running a tape around a large object would suffer from any inconsistency in level as well as slack in the tape.

As stated previously, there was a device in the seventeenth century called a circumferentor to determine circumference by ratio but it did not involve an adaptation of the magnetic compass as the Compass Ruler does.

B) Measuring the Angle Between Two Walls.

This would include checking or setting up a right angle as would be done with a builder's square to be sure that the corner is square. It would be done using the Compass Ruler by simply zeroing the needle against one wall and notina the starting point and then placing the starting point against the other wall FIG. 8. The Compass Ruler should then read 90 degrees off the zero point if the corner is in fact square FIG. 8a-b.

But the Compass Ruler offers tremendous advantages over the builder's square in such a situation. The builder's square FIG. 9 can only measure right angles easily unless the user is highly skilled in its use or has a considerable knowledge of trigonometry. In contrast, the Compass Ruler can measure any angle easily and can tell exactly how much off square a corner is.

The builder's square cannot have any great accuracy because it can only take a measurement as far as its two arms can reach. The Compass Ruler in contrast, can get a truer measurement of a corner, whatever it's angular measure may be, by taking its measurements further back from the corner at any desired points and then comparing the measurements with great accuracy.

There is another way of verifying a right angle. The Pythagorean theorem FIG. 10 states that C squared=A sq+B sq. This can be used to verify a right angle with considerable accuracy. If we measure 4 units along one side of a right angle and 3 units along the other side, the line connecting the two end points should be exactly 5 units if it is indeed a right angle because 4 sq=16 and 3 sq=9 and the two added equals 25 as does 5 sq. This can be done using rulers or tapes while building a wall or fence to measure 3, 4 and, 5 feet. However, this is a very cumbersome way to verify a right angle in comparison with the Compass Ruler. Also, the pythagorean method is limited to right angles, unlike the Compass Ruler. One of the objects of the Compass Ruler is to make any angle in a building project just as easy to construct as a right angle.

Suppose that it is desirable in a workshop or laboratory of some kind to set a door open at a certain angle so that it will allow a precise amount of light or ventilation. The Compass Ruler, unlike any other common method, will allow the door to be set to the exact degree, or other unit, of the desired angle FIG. 11a-b.

C) Measuring Angular Relationship of Non-Intersecting Walls or Structures.

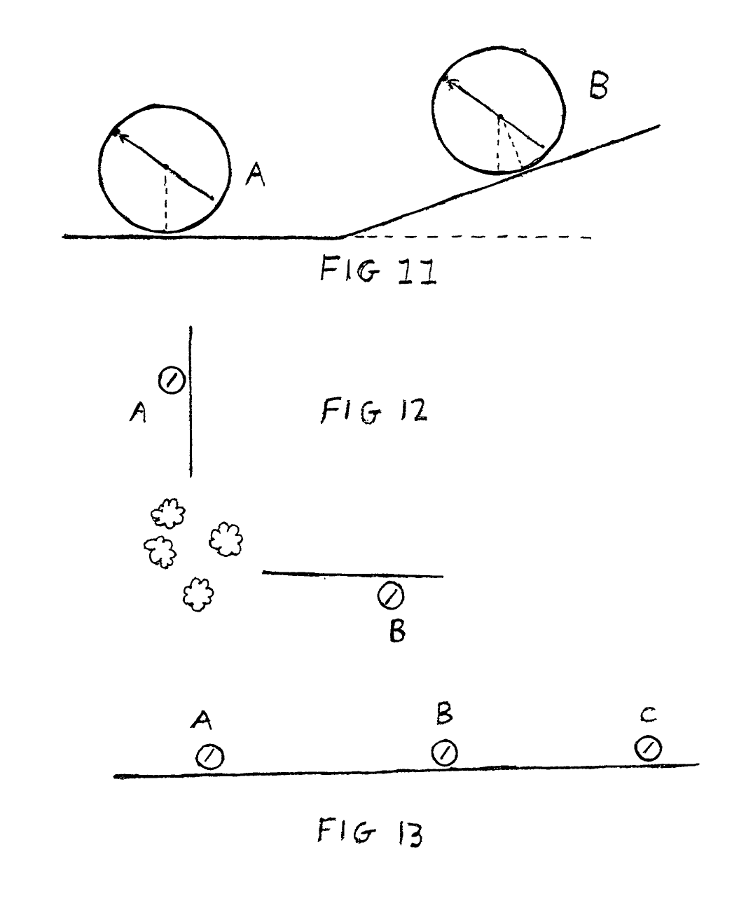

Suppose it is necessary to measure the angle between two walls that do not actually intersect FIG. 12. With the builder's square it is impossible, with mason's string it is very tedious even if the walls come close to each other, with a surveying team it is expensive. With the Compass Ruler it is quick and easy no matter how far apart the walls are. If a wall is to be continued along the same axis after a break the same principle applies. Distance is of little concern in operation of the Compass Ruler, unlike mason's string. And unlike a surveying team, it is not an inconvenience for the walls to not be within a clear line of sight.

D) Verifying Straightness or Curvature of a Wall or Fence.

No need for time-consuming setup of mason's string. The Compass Ruler will tell easily whether the wall or fence is straight or if not, just how far off it is. Curvature or straightness can be measured by difference in angle on the Compass Ruler vs distance between measurement points, which can be measured by rotating the Compass Ruler along the surface of the wall or fence, since the Compass Ruler is of precisely known circumference.

This technique should consist of zeroing the Compass Ruler against the wall or fence and noting the numbered point of contact between the edge of the Compass Ruler and the wall or fence and then placing the same numbered contact point on the Compass Ruler against the wall or fence at intervals and noting if the needle position varies from the zero point or not FIG. 13.

E) Checking Whether Walls or Fences are Parallel or Have the Same Curvature.

Without the Compass Ruler, this would involve tedious measuring of the distance between opposite points on the walls. If the distances are the same when measured between two sets of opposite points, the walls can be assumed to be parallel as long as both walls are straight lines. Or if opposite points on curved sections zero the Compass Ruler at the same contact point, the sections are positioned congruently.

With the Compass Ruler, simply zero the magnetic needle against one wall and note the numbered point which contacts that wall. Then place that contact point against the other wall and note where the magnetic needle comes to rest FIG. 14. If the walls are indeed parallel, the needle should point to the 180 degree mark away from the zero point.

With the Compass Ruler, unlike the above stated cumbersome measurements necessary without the Compass Ruler, distance between the walls is of little concern and it is not necessary to take care to measure directly opposite point on the two walls as long as the walls are straight, which can of course also be easily determined with the Compass Ruler as described in technique D. Once again, unlike a surveying team, the Compass Ruler is not inconvenienced at all by visibility being blocked.

F) Measuring the Distance to a Distant Object or Point.

The Compass Ruler can employ parallax to measure the distance to a distant object using a baseline FIG. 16a. A straight edge FIG. 18 is used with the Compass Ruler to set up a perpendicular baseline FIG. 16a AC to the line between the chosen measurement point and the distant object AB. A convenient unit of distance is chosen for the length of the baseline, short enough to easily measure but long enough to ensure accuracy in the distance measurement. The further away the object is from the measurement point, the less accurate this method will be but the longer the baseline, the more accurate it will be.

Accuracy also depends on the angular measurement accuracy of the right angle between measurement line and baseline BAC and also on the choice of a concise point on the distant measurement object to fix the measurement lines. Use of a laser pointer mounted on a straightedge would be ideal here. This technique obviously requires that the distant object be clearly visible and that there be the necessary space to set up a baseline.

Measuring the distance to a distant object or point is probably the only technique described here in which the accuracy of the Compass Ruler may be slightly less than that of a surveying team. But most distance measurements of a kilometer or less done for a wide variety of reasons, such as setting up a fairground, do not require the pinpoint accuracy that surveying tasks such as setting up property lines do. The Compass Ruler will be more than adequate for virtually all unofficial applications, as well as far less expensive. The scopes that measure distance by having the user bring the object into focus in a lens system do not have the accuracy of the Compass Ruler used with a straightedge.

In this technique, the Compass Ruler is used to ensure that the baseline AC is at a 90 degree angle to the measurement line AB (as in technique B). Using the straight edge alongside the Compass Ruler, the angular difference in degrees is measured between the line from the measurement point to the distant measurement object AB and the line from the opposite end of the baseline to the distant measurement object CB.

When this angular difference is determined, all that is necessary to determine the distance from the measurement point to the distant measurement object is to take the cotangent (the reciprocal of the tangent) of the angular difference and multiply it by the length of the baseline.

Astronomers have long used this technique to measure distances to stars but it apparently never found it's way into use for everyday tasks until now. It is not absolutely necessary to have the right angle at the measurement point A, but then the simplicity of the cotangent calculation cannot be used and a graphical calculation will be necessary.

This technique can also be used to measure the distance between two distant objects by measuring the distance between them from a chosen measurement point and then the angle between them from the same point FIG. 19. This technique is very useful for inaccessible but visible objects such as trees in a swamp. The inter-object distance can then be found using methods such as graphical or trigonometric triangulation. A map of visible distant objects can be made by repeatedly using this technique on a number of objects.

The reverse of this measurement technique FIG. 16b can also be easily accomplished with the Compass Ruler. Suppose a field or lot is being measured off and it is necessary to place a marker or pole at a certain distance in a given direction from a base point A.

The above described technique would be set up in reverse with a baseline of convenient length AB using carefully placed markers. The angle between the baseline and the line from the end of the baseline to the desired distant point ABE would be determined by dividing the intended distance by the length of the baseline and calculating what angle has the result of that calculation as a cotangent.

A line at that angle to the baseline would then be set up using the Compass Ruler and marked D. Another marker would then be placed at the end of the baseline B. Two more markers would be placed, one at the original measurement point A and one on the line from the measurement point in the direction of on the line to the yet to be determined distant point C. All that would then be necessary to pinpoint the distant point would be to find, visually or otherwise, the point at which two lines formed by the four markers intersect E.

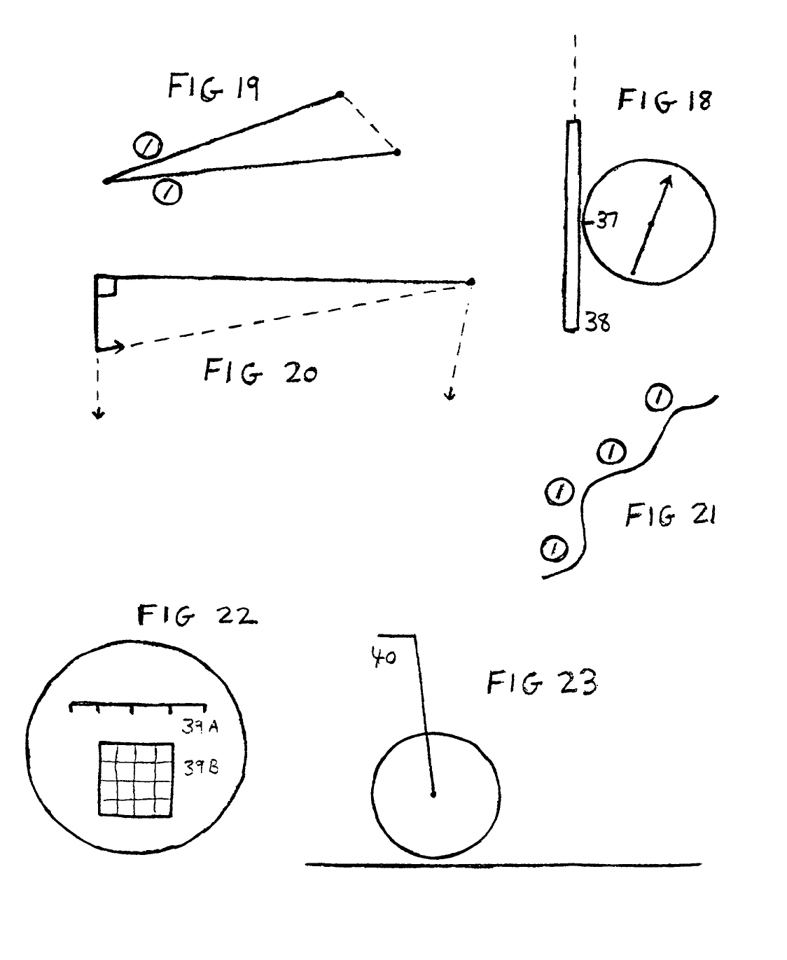

Of course, once a distance has been determined using either variation of this method, that distance can then be used as a baseline to measure a greater planar distance in the opposite dimension FIG. 20.

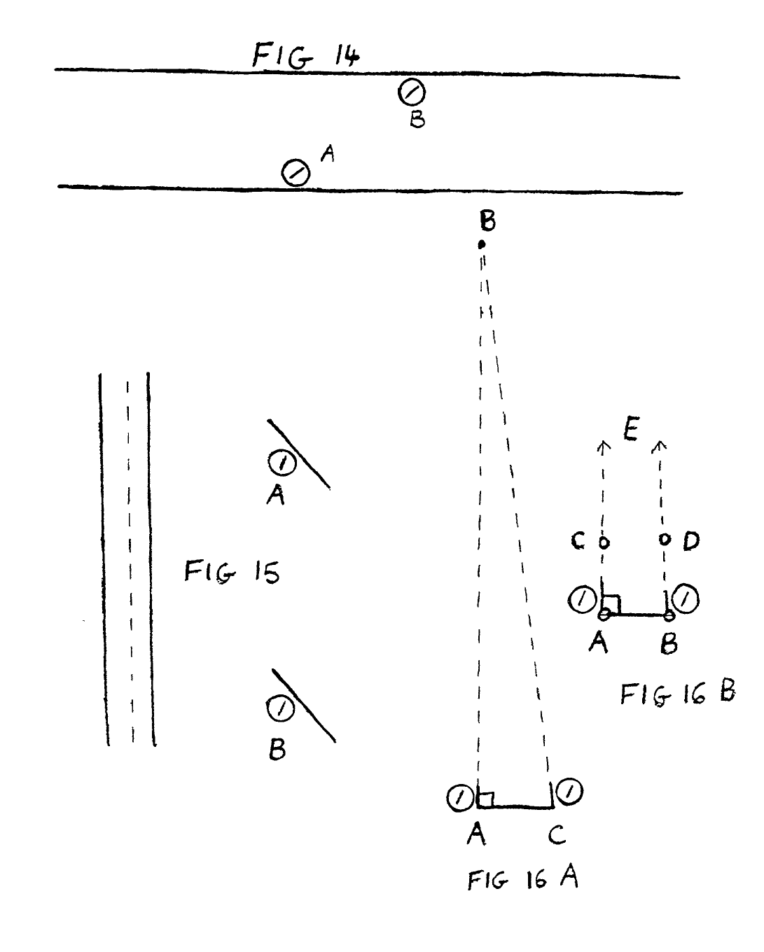

This technique can be varied to determine the angular attitude as well as the placement of signs along a road so that all are at the same angle relative to the road FIG. 15.

G) Cartography.

The Compass Ruler is ideal for taking the measurements used in making maps. Especially small-scale maps such as that of a field or wooded area or a college campus. All of the above-described applications can be creatively combined to produce an accurate and detailed map. A path, trail or, stream which is twisting or winding can be charted by recording the reading of the straight-ahead direction at interval distances along the path FIG. 21.

Distances along the path could be measured in ways such as paces, a pedometer or, a bicycle odometer. This technique can be used as a variation of technique A to chart the outline of a large, irregularly shaped object such as a rock or hill.

The angular difference between a road and the side of a building or between two buildings can be measured with great accuracy using the Compass Ruler. In addition of course, being a magnetic compass enables the Compass Ruler to measure compass direction as well. Most small-scale maps do not need the extreme accuracy (or expense) that a surveying team offers. The Compass Ruler will be a classroom essential in cartography as well as trigonometry and geometry.

H) Measurement of Linear Distance.

Probably the simplest use of the Compass Ruler is linear measurement is using it as a wheel, counting the number of rotations and, multiplying it by the circumference of the Compass Ruler FIG. 23. For this purpose, the edge of the Compass Ruler could be inscribed or marked in increments as well as in degrees or other angular measure.

Used in this capacity, the Compass Ruler would be easier and less cumbersome to use than a tape measure. As stated previously, the Compass Ruler would be made with some type of non-slip edge for to prevent or minimize slippage while being rotated along a surface being measured.

### CONCLUSION, RAMIFICATIONS AND, SCOPE

Accordingly, the reader will see that the possible applications of the compass ruler in common building tasks is widespread. The Compass Ruler's primary competitors will be the builder's square, tape measure and, mason's string. There are a vast number of tasks that are extremely cumbersome or impossible with any of these tools which are easy with the Compass Ruler. A surveying team could, of course, be called in to do the tasks the Compass Ruler is being used for but the drawback to that is the expense and inconvenience.

The Compass Ruler is the effective equivalent of a tape measure, builder's square, mason's string and, distance-measuring scope all in one lightweight and easily portable tool requiring only one user, making creation of angles and curves in home building projects easier than ever before.

The Compass Ruler can be made to any desired size but will most likely be made to a convenient unit circumference such as as one yard or one meter.

The body of the Compass Ruler will probably be made of a lightweight and break-resistant material such as plastic or aluminum but is not limited thereby and may conceivably be made of any material.

The Compass Ruler may have notched, instead of smooth, sides to make measurement more accurate. As an example, the body of the Compass Ruler may be made as a polygon of 360 sides to enable accurate measurement to each degree of the circle.

The pointer of the Compass Ruler may be made of any material and is not limited in shape. The only requirement of the pointer is that it serve it's purpose, possibly by being made magnetic-tipped. The needle may not be used as the pointer if some replacement for it can be effectively used. For example, a movable magnetic piece on a track along the outside of the Compass ruler could serve as the pointer and thus take the place of a needle.

The mounting or suspension of the needle (if used) in the Compass Ruler will probably be done as in a traditional magnetic compass but is not limited to this.

The “compass” part of the Compass Ruler may or may not occupy the entire diameter of the body (if circular). The two effective body sections, the base and the top, either of which may be composed of subsections, may be made to different sizes and the measurement calibrations may be on either section.

This patent does not define either a length of the needle, if a needle should be used as the pointer, or the ratio of its length to the radius of the body of the Compass Ruler. The needle, or any replacement that might be used for it, may or may not end or reach to either the edge of the section of the body of which it is a part or the effective edge of the Compass Ruler. Readability with the calibration of the Compass Ruler is the vital criteria.

Being a magnetic compass will enable the Compass Ruler to measure direction as well and it may or may not be calibrated to compass direction. Since the Compass ruler is likely to be used only or mostly in one geographic locality, an adjustable directional calibration may be included. The traditional magnetic compass was used in travelling so such a directional calibration was never truly practical.

The needle or other direction-pointing mechanism on the Compass Ruler may be either north-pointing or south-pointing.

The Compass Ruler can be made in any color or colors and can be made so in decorative appearance.

It will be possible to modify the Compass Ruler for many other tasks. Any such modifications are within the scope of this patent.

In order to make it as complete a measurement device as possible, the Compass Ruler may have other measurement calibrations included at some place on its body such as a standard inch or centimeter ruler or a table of angle cotangents for use with operations techniques F and G.

The Compass Ruler will most likely be used with the earth's magnetic poles, but will not be limited to this. It may be used as a pointer to some local magnetic field, whether natural or synthetic. The Compass Ruler may be specially modified for such a use. In addition, the Compass Ruler can be used for tasks informally done by the traditional magnetic compass such as detecting an electric current in a wire.

The Compass Ruler may include a “leash” for linear measurement as in operations technique H or any other addition which makes it's use easier.

The Compass Ruler may be combined with another device for easier use in a specific operation. An example of this is combining the Compass Ruler with a laser pointer straightedge for use in distance measurement as in operations techniques F and G.

The Compass Ruler may be combined with another device or tool. An ideal example of this would be a plumb to measure vertical angles, using earth's gravity as a reference point, combined on the same body with a Compass Ruler to measure horizontal angles, using the earth's magnetic field as a reference point. In use of the Compass Ruler for mapping, an attached plumb would come in very handy for hilly terrain cartography. Such an included plumb would most likely be on the opposite side of the body to the Compass Ruler face.

The most obvious shape for the Compass Ruler, or the functional part thereof, is circular but this is not a limitation and other shapes in the use of the magnetic compass for linear or angular measurement are possible. For example, the Compass Ruler can be modified to a shape such as semi-circular and mounted on a billboard to measure it's sway in the wind. The Compass Ruler could be specially made to right angle or any other angle if a large number of angle verifications in some type of construction or manufacturing have to be done.

This patent includes any automations of the functions of the Compass Ruler including the electronic version in the description section of this patent.

Any specificities in the description should not be construed as limiting the scope of the invention but to give examples of it's many uses. The scope of the Compass Ruler should be decided by the claims instead of examples of usage provided.

I claim:

1. A method of adapting the principle of the traditional magnetic compass to precise planar measurement using the magnetic field as a fixed reference point. Comprising the steps of:
1) Constructing a body of precise and convenient dimensions.
1b) The body should have a slip-resistant edge.
1c) The body, if circular, may be a smooth circle or notched, such as a polygon with 360 sides, one side for each degree of a complete circle.
2) Including a magnetic pointer movable in relation to the body.
2a) Pointer may be a needle, entirely magnetic or partially magnetic.
2b) Any substitute may be used for a needle that effectively constitutes a pointer.
3) Including calibration with units of measurement to be read by the pointer.
3a) Units of measure on calibration are chosen to fit the intended type of measurement.
